(19) United States
(12) Patent Application Publication
(10) Pub. No.: US 2009/0026955 A1
(43) Pub. Date: Jan. 29, 2009

(54) Discharge Lamp With a Cast Base

(75) Inventors: Jorg Otterstatter, Gerstetten (DE); Jorg Rink, Syrgenstein (DE)

Correspondence Address: OSRAM SYLVANIA INC, 100 ENDICOTT STREET, DANVERS, MA, 01923, US

(73) Assignee: Osram Gesellschaft Mit Beschrankter Haftung, Munchen (DE)

(21) Appl. No.: 12/223,672

(22) PCT Filed: Jan. 30, 2007
(86) PCT No.: PCT/EP2007/050878

§ 371 Date: Aug. 6, 2008

(30) Foreign Application Priority Data
Feb. 7, 2006 (DE) 20 2006 001 907.3

(51) Int. Cl. H01J 61/36

(52) U.S. Cl. 313/624

(57) ABSTRACT

A discharge lamp with a cast base has two electrodes for feeding power into the discharge vessel, two current feeds for making contact with the electrodes from the outside and a lamp base with a recess for receiving one end of the discharge vessel. In this context, one end of the discharge vessel is introduced into the recess in the lamp base. Between the lamp base and the discharge vessel there is an intermediate space. The current feeds are located at least partially within the intermediate space. This intermediate space has been cast with a sealing compound so that the sealing compound fills at least part of the interspace and encloses the end of the discharge vessel in such a way that the current feeds of the discharge lamp are sealed off from the outside in so far as being located within the lamp base.

### TECHNICAL FIELD

The present invention relates to a discharge lamp with a base.

### PRIOR ART

Discharge lamps are in widespread use and are known in a very wide variety of embodiments. The discharge vessels of the discharge lamps are often tubular.

In order to ignite a discharge in the discharge medium provided in the discharge vessel, power is coupled into the discharge vessel via electrodes. Often, these electrodes are filaments lying within the discharge vessel.

In the case of dielectric barrier discharge (DBD) lamps, the interior of the discharge vessel is separated from the electrodes by a dielectric. There are designs in which the dielectric barrier electrodes rest on the outside on the discharge vessel wall; in these cases the discharge vessel wall is the dielectric. The process of coupling power in by means of dielectric barrier electrodes is based on a high-frequency displacement current within the dielectric, i.e. capacitive coupling.

There are also outer electrodes which couple power in substantially inductively.

Occasionally, discharge lamps with outer electrodes are referred to as “electrode-free”; this choice of wording cannot be applied here.

Normally, the discharge vessel has a base at least one of its ends, i.e. at least one discharge vessel end is fastened in a lamp base. It is conventional to pass power supply lines, for example contact pins, through the lamp base which are electrically conductively connected to the electrodes. Then, the power required for operation is supplied to the discharge lamp in the discharge lamp holder via the power supply lines.

In the case of linear dielectric barrier discharge lamps, for production purposes generally one of the discharge vessel ends is plugged into an appropriately sized cutout of the lamp base. Prior to this, an adhesive has been introduced into this cutout. After curing, the adhesive holds the lamp base and the discharge vessel together. The power supply lines can be connected to the electrodes of the discharge vessel even before this plugging-together process. For this purpose, the lamp base has appropriately sized holes, through which the power supply lines are passed during the plugging-together process, with the result that said power supply lines then protrude partially out of the lamp base.

### DESCRIPTION OF THE INVENTION

The present invention is based on the object of specifying an improved discharge lamp with advantageous base fitting.

This object is achieved by a discharge lamp with a tubular discharge vessel, which has: two electrodes for coupling power into the discharge vessel, two supply lines for making contact with the electrodes from the outside, and a lamp base with a cutout for accommodating one end of the discharge vessel, wherein one end of the discharge vessel is introduced into the cutout of the lamp base, an interspace exists between the lamp base and the discharge vessel, and the power supply lines lie at least partially within the interspace, characterized in that the interspace has been cast with a casting compound, with the result that the casting compound fills at least part of the interspace, and the casting compound surrounds the discharge vessel end in such a way that the power supply lines of the discharge lamp, insofar as they lie within the lamp base, are sealed off from the outside.

Preferred configurations of the invention are specified in the dependent claims and will be explained in more detail below.

The invention is based on the knowledge that, in the case of a discharge lamp produced in accordance with the prior art, there is no guarantee that the parts of the power supply lines which lie within the cutout of the lamp base are sealed off reliably and permanently from the outside.

In the case of the DBD lamps mentioned at the outset, adhesive located in the cutout is distributed, by means of the discharge vessel and the lamp base being plugged together, in an interspace formed in the process. The resultant adhesive distribution in the interspace is difficult to control and is to a certain extent random, however. In any case it is not guaranteed that the electrically conductive component parts of the discharge lamp are in this way sealed off reliably from the outside.

In the case of a discharge lamp according to the invention, first one of the discharge vessel ends is introduced into the cutout of the lamp base in order to then be cast with a casting compound. The casting compound should in this case fill at least part of the interspace and surround the discharge vessel end located in the cutout in such a way that the electrically conductive component parts of the discharge lamp are sealed off from the outside. One advantage of the casting is in this case that the casting of a casting compound can be performed in a more controlled manner than the distribution of an adhesive by means of the discharge vessel and the lamp base being plugged together. The casting compound distribution resulting during casting in the interspace is determined by the casting process and is not purely random, as in the case of the pressing-type distribution of adhesive. For example, the casting compound can be supplied to the interspace through a nozzle with a fixed pressure, at a certain angle and in a certain quantity.

As a result of the selection of a particularly low-viscosity casting compound, the distribution of this casting compound in the interspace can be assisted.

In a preferred embodiment of the invention, the interspace between the discharge vessel and the lamp base is completely filled with the casting compound.

In addition to the fact that in this case the electrically conductive component parts of the discharge lamp are sealed off from the outside in a particularly reliable manner, such a joint can also be very stable.

Preferably, the electrodes for coupling energy into the discharge vessel are dielectric barrier electrodes, in the case of which the electrodes are separated from the interior of the discharge vessel by a dielectric. For example, the electrodes can be fitted on the outside of the discharge vessel; the dielectric is then the discharge vessel wall. If the electrodes lie within the discharge vessel, an additional dielectric is applied to the electrodes. Usually, the electrodes are elongate and run over a relatively large proportion of the discharge vessel. Dielectric barrier electrodes are particularly advantageous because the discharge lamps fitted with them exhibit particularly high switching strength, generally do not contain any mercury and correspondingly do not have a startup response.

There are discharge vessels which do not have smooth terminations at one or both of their ends but have protruding structures and cavities located between them (see exemplary embodiments). Examples of these are discharge vessel forms in which the discharge vessel is not sealed off directly at the end of the tubular discharge vessel outer surface but a terminating end face is set back slightly into the interior of the discharge vessel, with the result that the discharge vessel casing forms a rim around this end face. In a preferred embodiment of the invention, the casting compound is therefore cast through a casting opening opposite the end side of the discharge vessel end. Then, the casting opening is positioned in such a way that the casting compound can also easily fill the end-side cavity during the casting. This has the advantage that cavities between the discharge vessel and the lamp base are avoided and thus the reliability of the sealing of the electrically conductive component parts can be increased. Such casting can also have a positive effect on the stability of the joint since the surface which is in contact with the casting compound is enlarged.

Preferably, the casting compound is a multi-component casting compound. The mixed components can be introduced into the interspace between the discharge vessel and the lamp base and react with one another chemically within the interspace. There are multi-component casting compounds which flow very well in the unreacted state even without any heating and thus can fill the interspace between the lamp base and the discharge lamp well even at unfavorably positioned points. Single-component casting compounds often have the disadvantage that they cannot be stored over a relatively long period of time, for example overnight, without their viscosity noticeably increasing. The individual components of a multi-component casting compound, on the other hand, can generally be stored over a longer period of time, for example days, without noticeable changes in viscosity. This is advantageous in particular when a machine for casting is not operated 24 hours a day.

Preferably, the interspace filled with the casting compound is sealed off from the outside by a sealing ring, the sealing ring surrounding the tubular discharge vessel. The sealing ring can be introduced into the interspace by it brushing over the discharge vessel and being introduced into the lamp base together with the discharge vessel. In this case, the sealing ring surrounding the tubular discharge vessel fills the entire gap between the discharge vessel wall and the base with its cross section.

During production, the sealing ring allows for cleaner casting of the interspace through a casting opening, for example one as described above, without the lamp base and the discharge vessel absolutely being matched to one another.

In a preferred embodiment of the invention, an ignition ring which surrounds the discharge vessel is introduced into the interspace. An ignition ring has an electrically conductive material and facilitates the ignition of the discharge via the electrodes by means of local field distortion. For this purpose, it is not necessary for the ignition ring to be at a certain potential or for it to be electrically conductively connected to any particular component part of the discharge lamp or to an electronic ballast.

In the case of dielectric barrier discharge lamps with outer electrodes, it is expedient to electrically insulate the ignition ring from the electrodes; for example the electrodes can be covered in the region of the ignition ring with a surge-proof insulating film.

Preferably, the sealing ring also acts as an ignition ring; this is possible, for example, by virtue of the fact that a conductive material is introduced into the sealing ring.

In this way, the advantages of a sealing ring and an ignition ring are provided, but only one ring needs to be introduced into the interspace between the lamp space and the discharge vessel.

There are also electrically conductive plastics, for example elastomers mixed with metal particles. Preferably, the ignition ring has such an elastomer. Ideally, it consists of a conductive elastomer.

In the case of dielectric barrier discharge lamps with electrodes lying within the discharge vessel, the electrode material is generally passed through the discharge vessel wall itself, bears against said discharge vessel wall and thus forms part of the power supply line. Preferably, contact is made with such power supply lines or electrodes bearing against the discharge vessel via conductive spring elements. For example, these spring elements can be fixedly connected to the lamp base even before the discharge vessel is introduced into the cutout of the lamp base and can press against the power supply lines bearing against the discharge vessel end when the discharge vessel is introduced. It is particularly preferred if the spring elements have structures, for example small barbs, which, when they press against the power supply line or the electrodes which are passed out, hook into them such that the spring elements and the electrodes enter into a very intimate connection.

Sometimes, discharge lamps are provided with a base not only at one end but at both ends. The second end does not need to, but can have possibilities for coupling power into the discharge vessel. Preferably, a discharge lamp according to the invention is supplemented by a second lamp base, which has a cutout for accommodating one end of the discharge vessel, the other end of the discharge vessel having been introduced into the cutout of the second lamp base, and a second interspace existing between the second lamp base and the discharge vessel. In this case, a casting compound has been cast into the second interspace, with the result that the casting compound fills at least part of the second interspace and the casting compound surrounds the discharge vessel end in such a way that the cutout is sealed off from the outside.

This is particularly advantageous in terms of production engineering since it is not necessary to use different methods for fastening the discharge vessel in a lamp base.

Preferably, this second interspace is also completely filed with the casting compound.

In a preferred embodiment, the discharge lamp according to the invention is designed for emission in the ultraviolet wavelength range.

It is conceivable to use such a discharge lamp for example in the automotive sector, for example for air conditioning purposes in an air-conditioning unit. It is particularly important here to protect the power supply lines of the discharge lamp since automotive parts are expected to have a particular level of resistance to fluctuations in temperature and humidity.

If, for example, a lamp is used for light conditioning which emits particularly short-wave ultraviolet light, for example in the VUV range (vacuum UV; for example Xeradex by OSRAM GmbH with a wavelength of 172 nm), highly reactive radicals may be produced in the environment of the discharge lamp and thus a very corrosive environment may be created. If a lamp is used which emits ultraviolet light with a longer wavelength (for example Linex by OSRAM GmbH, which emits in the UVA range), these irradiate, for example, a catalyst in order to thus accelerate or enable for the first time reactions taking place on the surface of the catalyst. Precisely in such corrosive environments it is important that the interspace between the discharge vessel and the lamp base is well protected, so that the electrically conductive component parts of the discharge lamp cannot be damaged by the corrosive environment and possibly further environmental influences.

The description above and below relating to the individual features relates to the apparatus category and also to a production method corresponding to the invention without this explicitly being mentioned in detail.

The invention in principle therefore also relates to a method for producing a discharge lamp with a tubular discharge vessel which has two electrodes for coupling power into the discharge vessel, two power supply lines for making contact with the electrodes from the outside and a lamp base with a cutout for accommodating one end of the discharge vessel, having the following step: introduction of one end of the discharge vessel into the cutout of the lamp base, an interspace being produced between the lamp base and the discharge vessel, and the power supply lines lying at least partially within the interspace, characterized in that the production method has the further step as follows: subsequent casting of the interspace with a casting compound, with the result that the casting compound fills at least part of the interspace and the casting compound surrounds the discharge vessel end in such a way that the power supply lines of the discharge lamp which lie within the lamp base are sealed off from the outside.

Finally, the invention also relates to the configurations explained above and below which are always also implicitly intended for this method.

### BRIEF DESCRIPTION OF THE DRAWINGS

The invention will be explained in more detail below with reference to the exemplary embodiments. The individual features disclosed in this case can also be essential to the invention in other combinations.

FIG. 1 shows a detail of a cross section through a first discharge lamp according to the invention.

FIG. 2 shows a detail of a cross section through a second discharge lamp according to the invention.

### PREFERRED EMBODIMENT OF THE INVENTION

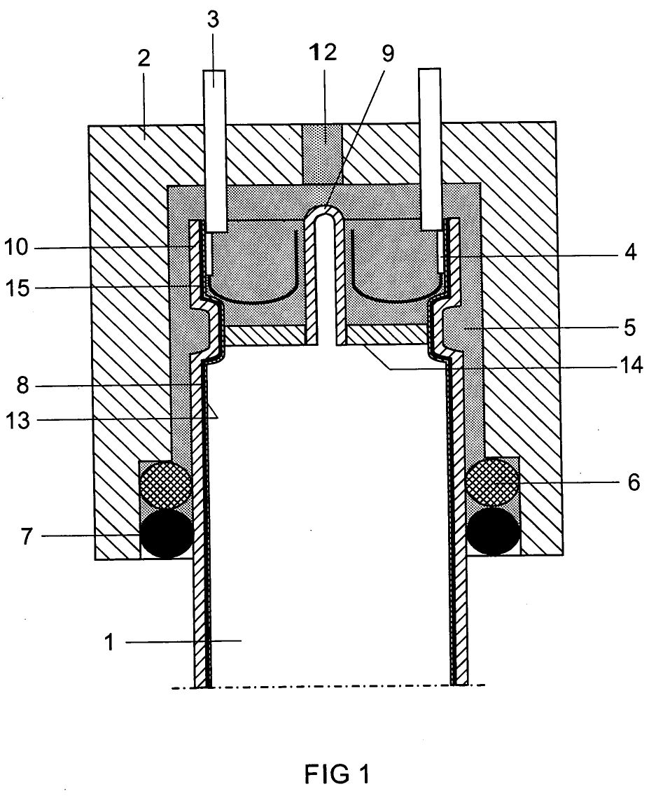

FIG. 1 shows a discharge vessel end 1, which is introduced into a lamp base 2, in cross section.

An interspace, which has been filled with a two-component casting compound 5, is located between the discharge vessel end 1 and the lamp base 2.

The discharge vessel end 1 is sealed off by an end face 14. The end face 14 is set back slightly into the interior of the tubular discharge vessel 1, with the result that the casing 10 protrudes beyond this end face 14 and around said end face. An exhaust stem 9 which has been fused closed is located centrally in the end face 14.

Dielectric barrier electrodes 8 lying within the discharge vessel 1 can be used to couple power into the discharge vessel 1. Within the discharge vessel 1, the electrodes 8 are separated from the interior of the discharge vessel 1 by a dielectric 13, in this case glass solder. The electrodes 8 are electrically conductively connected to contact faces 15, which bear on the inside against the casing of the discharge vessel 1, which casing protrudes beyond the end side 14. These contact faces 15 are in the form of continuous metal layers. In order to produce the electrically conductive contact between the electrodes 8 and the contact faces 15, said contact faces 15 are passed through the end face 14.

Contact pins 3 are passed through the base and have spring elements 4 at their ends, which spring elements are pressed against the contact faces 15, which lie outside the discharge vessel 1 (alternatively cables can also be passed through the base; not shown). The electrically conductive spring elements 4 in this case have barbs (not shown), with which they have become hooked into the surface of the contact faces 15, with the result that a particularly intimate connection is provided; alternatively, the contact faces 15 can also be soldered to the spring elements 4.

Since the discharge vessel end 1 does not terminate smoothly, but the rim 10 and the exhaust stem 9 also protrude beyond the end face 14, a toroidal cavity is formed here. It should be noted that this cavity has also been filled with the two-component casting compound 5.

The interspace which has been filled with the two-component casting compound 5 is sealed off by an ignition ring 6, which surrounds the discharge vessel end 1, and a sealing ring 7, which likewise surrounds the discharge vessel end 1. The sealing ring 7 in this case bears directly against the discharge vessel wall and, in terms of its cross section, fills the entire distance between the discharge vessel wall and the lamp base 2. The ignition ring 6 has a slightly larger inner diameter. The two-component casting compound 5 is located between the two rings 6′ and 7.

The lamp base 2 has a hole 12, which is filled with the two-component casting compound 5 and through which the casting compound 5 has been introduced into the interspace between the discharge vessel 1 and the lamp base 2.

The discharge lamp is produced as follows: the two contact pins 3 with in each case spring elements 4 fastened thereon are passed through the base wall and fastened. Then, the discharge vessel end 1 is introduced into the lamp base 2, with the result that the spring elements 4 press against the contact faces 15 on the rim 10. Contact pins 3, spring elements 4 and contact faces 15 therefore together form the power supply lines 3, 4, 15 to the electrodes 8.

An ignition ring 6 and a sealing ring 7 are positioned in advance around the discharge vessel end 1. The sealing ring 7 encloses the discharge vessel end 1 in such a way that the interspace between the discharge vessel end 1 and the lamp base 2 is sealed off from the outside. The ignition ring 6 in this case has a slightly larger inner diameter, with the result that two-component casting compound 5 can flow past it.

The two-component casting compound 5 is cast through the casting opening 12, with the result that the entire interspace is filled with this casting compound 5. In the process, the sealing ring 7 prevents the two-component casting compound 5 from escaping.

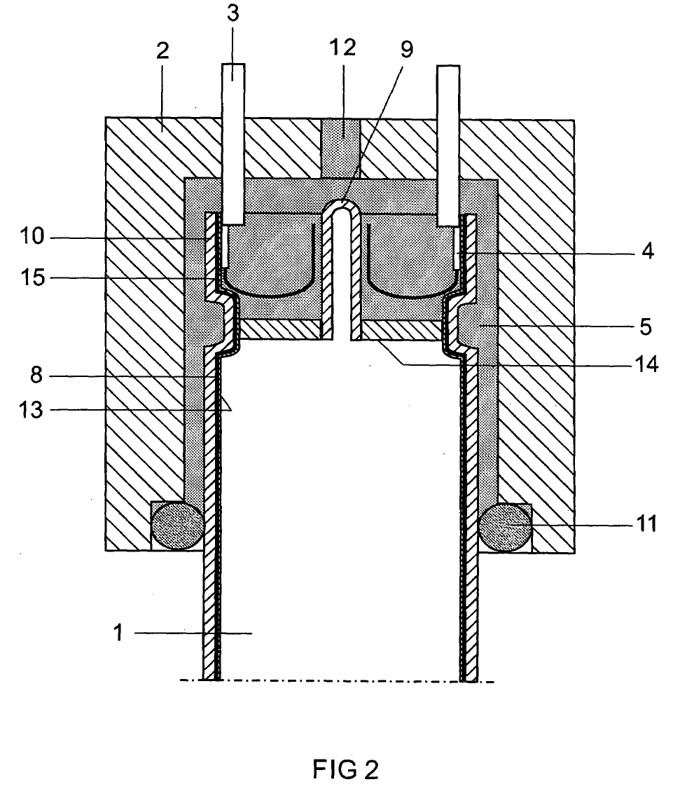

FIG. 2 shows a second exemplary embodiment. Component parts which correspond to those in the first exemplary embodiment from FIG. 1 are in this case denoted by the same numerals as in FIG. 1 and will also not be explained any further. In contrast to the first exemplary embodiment, the discharge lamp end 1 is not surrounded by an ignition ring 6 and a sealing ring 7, but by a ring 11 made from a conductive elastomer. The ring 11 has been substantially positioned and also introduced in the same way as the sealing ring in FIG. 1 and also performs its sealing function. Since it is produced from a conductive elastomer, it also acts as an ignition ring.

1. A discharge lamp with a tubular discharge vessel (1), which has:
two electrodes (8) for coupling power into the discharge vessel (1),
two supply lines (3, 4, 15) for making contact with the electrodes (8) from the outside, and
a lamp base (2) with a cutout for accommodating one end of the discharge vessel (1),
wherein
one end of the discharge vessel (1) is introduced into the cutout of the lamp base (2),
an interspace exists between the lamp base (2) and the discharge vessel (1), and
the power supply lines (3, 4, 15) lie at least partially within the interspace,
characterized in that the interspace has been cast with a casting compound (5), with the result that the casting compound (5) fills at least part of the interspace, and
the casting compound (5) surrounds the discharge vessel end (1) in such a way that the power supply lines (3, 4, 15) of the discharge lamp, insofar as they lie within the lamp base (2), are sealed off from the outside.

2. The discharge lamp as claimed in claim 1, in which the interspace is completely filled with the casting compound (5).

3. The discharge lamp as claimed in claim 1, in which the electrodes (8) are dielectric barrier electrodes (8).

4. The discharge lamp as claimed in claim 1, in which the interspace has been cast with the casting compound (5) through a casting opening (12) opposite the end side (14) of the discharge vessel end (1).

5. The discharge lamp as claimed in claim 1, in which the casting compound (5) is a multi-component casting compound.

6. The discharge lamp as claimed in claim 1, in which the interspace filled with the casting compound (5) is sealed off from the outside by a sealing ring (7), the sealing ring (7) surrounding the tubular discharge vessel (1).

7. The discharge lamp as claimed in claim 6, in which an ignition ring (6, 11) which surrounds the discharge vessel (1) is introduced into the interspace.

8. The discharge lamp as claimed in claim 7, in which the ignition ring (6, 11) is also the sealing ring (10, 11).

9. The discharge lamp as claimed in claim 7, in which the ignition ring (6, 11) has an elastomer.

10. The discharge lamp as claimed in claim 1, in which the power supply lines (3, 4, 15) have conductive spring elements (4) and these spring elements bear against a respective part of the power supply lines (3, 4, 15) which lies outside of the discharge vessel end.

11. The discharge lamp as claimed in claim 1 with a second lamp base with a cutout for accommodating one end of the discharge vessel (1),
the other end of the discharge vessel (1) having been introduced into the cutout of the second lamp base,
a second interspace existing between the second lamp base and the discharge vessel,
the second interspace having been cast with a casting compound, with the result that the casting compound fills at least part of the second interspace, and
the casting compound (5) surrounding the discharge vessel end (1) in such a way that the cutout is sealed off from the outside.

12. The discharge lamp as claimed in claim 11, in which the second interspace is completely filled with the casting compound (5).

13. The discharge lamp as claimed in claim 1 which is designed for emission predominantly in the ultraviolet wavelength range.

14. The discharge lamp as claimed in claim 1, in which an ignition ring (6, 11) which surrounds the discharge vessel (1) is introduced into the interspace.

15. The discharge lamp as claimed in claim 8, in which the ignition ring (6, 11) has an elastomer.
